(19) United States
(12) Patent Application Publication
(10) Pub. No.: US 2008/0132591 A1
(43) Pub. Date: Jun. 5, 2008

(54) METHOD OF PRODUCING A THERMOPLASTIC POLYURETHANE COMPOUND

(76) Inventors: Gary M. Lawrence, Livonia, MI (US); Stephane Morin, Grosse Ile, MI (US); Rabeh Elleithy, Marinette, WI (US); Anand G. Huprikar, Novi, MI (US); Terry M. Kowalski, Wyandotte, MI (US); Heiner Wiecher, Plymouth, MI (US)

Correspondence Address: BASF AKTIENGESELLSCHAFT, CARL-BOSCH STRASSE 38, 67056 LUDWIGSHAFEN, LUDWIGSHAFEN, 69056, omitted

(21) Appl. No.: 11/565,672

(22) Filed: Dec. 1, 2006

(51) Int. Cl. C08G 18/00; C08J 11/04

(52) U.S. Cl. 521/49; 521/160

(57) ABSTRACT

A method of producing a thermoplastic polyurethane (TPU) compound including a polyurethane powder comprising microcellular polyurethane (MCU). The method minimizes discarding scrap MCU, reduces the cost of TPU articles by introducing a partial replacement for the TPU resin, and reduces injection-molding times to produce TPU articles. The TPU compound including polyurethane powder has superior melt temperature and compression set properties as compared to TPU compounds of similar Shore hardness that are free of the polyurethane powder. The invention also provides a TPU article including the TPU compound and a method of recycling a MCU foam.

### BACKGROUND OF THE INVENTION

1. Field of the Invention

The subject invention generally relates to a method of producing a thermoplastic polyurethane (TPU) compound. More specifically, the subject invention relates to a method of producing a TPU compound comprising a microcellular polyurethane (MCU).

2. Description of the Prior Art

Polyurethanes are a class of materials which offer unique physical properties and are suitable for use in a range of applications. Two types of polyurethanes include thermoplastic polyurethane (TPU) elastomers and microcellular polyurethane (MCU) foams. TPU elastomers are typically processed in an extruder or an injection molding device to produce elastomeric articles used in automotive, footwear, and medical applications. MCU foams are typically processed by mixing liquid components in a mold under low pressure in the presence of a blowing agent to produce foam articles that are also used in automotive and footwear applications.

As the prevalence of articles including MCU foams increases, the potential for an adverse environmental burden also increases. Typically, after use, the articles are disposed of in landfills and may create an adverse environmental burden. The articles may be in the form of a trimming, a slab, or a formed part, and may be disposed of after off-specification production or after an end use. Due to the potentially adverse environmental burden resulting from the disposal of the articles including the MCU foams, it would be advantageous to recycle the articles.

Various methods of recycling polyurethane elastomer's are known in the prior art. These recycling methods generally include chemical recycling, energy recovery, and mechanical recycling. An example of a mechanical recycling method is disclosed in the U.S. Pat. No. 5,908,894 to Genz et al. More specifically, Genz et al. discloses a process for preparing a TPU compound with reuse of a pulverized MCU. More specifically, the process prepares the TPU compound by reacting an isocyanate, a compound reactive towards an isocyanate, and optionally a chain extender, a catalyst, an auxiliary, and an additive such as a plasticizer with the pulverized MCU.

Although Genz et al. provides one method of producing a TPU compound from recycled polyurethane articles, there remains an opportunity for other methods of producing a TPU compound formed from recycled articles including MCU foams that do not require the use of a plasticizer. There also remains an opportunity to produce a TPU compound that has a higher melt temperature than other TPU compounds of similar Shore hardness. Further, there is an opportunity to produce a TPU compound that has a lower compression set than a compound produced from TPU resin alone, i.e. without MCU.

### SUMMARY OF THE INVENTION AND ADVANTAGES

The subject invention provides a method of producing a thermoplastic polyurethane (TPU) compound including a polyurethane powder comprising microcellular polyurethane (MCU). For the method, the polyurethane powder comprising MCU and a pre-formed TPU resin are provided. The polyurethane powder and the pre-formed TPU resin are processed together through a first apparatus to produce a first TPU compound. A supplemental amount of the pre-formed TPU resin and the first TPU compound are processed together through a second apparatus to produce a second TPU compound. The second TPU compound is the TPU compound of the subject invention. The subject invention also provides a TPU article including the second TPU compound and a method of recycling a pre-formed MCU foam.

The method of producing the TPU compound including the polyurethane powder comprising MCU, which may be either virgin MCU or scrap MCU, may eliminate the need to discard scrap MCU. Additionally, the method reduces the raw material cost of injection-molded TPU articles by introducing a replacement for a portion of the TPU compound necessary to produce the TPU article. The TPU article, by including the polyurethane powder comprising MCU, also has a higher melt temperature and a lower compression set than articles that only include TPU compounds of similar Shore hardness. The method also reduces injection-molding cycle times, as compared to injection-molding cycle times for TPU compounds only, due to the presence of the polyurethane powder comprising MCU.

### DETAILED DESCRIPTION OF THE INVENTION

The subject invention includes a method of producing a thermoplastic polyurethane (TPU) compound. The TPU compound melts at a higher temperature than other commercially available TPU compounds. The TPU compound also has at least a 40% lower compression set than other commercially available TPU compounds. Additionally, the TPU compound exhibits high elongation, elasticity, tensile strength, tear, and abrasion resistance, and hardness. Consequently, the TPU compound is suitable for forming articles used in automotive, medical, and footwear applications.

The method of producing the TPU compound comprises the step of providing a polyurethane powder comprising microcellular polyurethane (MCU). In one embodiment, the polyurethane powder may be provided as a pre-made product produced from a MCU foam. More specifically, the polyurethane powder may be obtained from a supplier. It is to be appreciated that the polyurethane powder may also include additional components other than the MCU.

In another embodiment, the MCU foam may be provided and pulverized to produce the polyurethane powder. The MCU foam may be a pre-formed MCU foam, such as, but not limited to, a slab, a trimming, or a formed article. Alternatively, the MCU foam may be virgin material that is prepared solely for processing with a pre-formed TPU resin. For purposes of the present invention, the method may include forming either the pre-formed MCU foam or the virgin material. However, it is to be appreciated that pre-formed MCU foam or virgin material may be provided from an outside source.

The pre-formed MCU foam is distinguished from the virgin material in that the pre-formed MCU foam is initially formed for another use and recycled by pulverization to produce the polyurethane powder. More specifically, the pre-formed MCU foam typically originates or is procured from a waste stream. Further, the pre-formed MCU foam may include a combination of different MCU foams, as described in further detail below, since the pre-formed MCU foam may be procured from multiple sources.

In contrast, the virgin material is specifically created to produce a polyurethane powder for processing with the pre-formed TPU resin and is procured from a product stream before being pulverized to form the polyurethane powder. Since the virgin material is prepared solely for processing with the pre-formed TPU resin, the virgin material typically comprises only one type of MCU foam.

MCU foams are formed through a two-step process, as known in the art. First, an isocyanate prepolymer is formed through an exothermic reaction of a polyol containing two or more hydroxyl groups and a diisocyanate. Next, the isocyanate prepolymer reacts with water to create a carbon dioxide offgas. A release of the carbon dioxide offgas creates a cellular structure. The cellular structure is then cured, and thereby completes the formation of the MCU foam.

The MCU foam may include methyldiphenyl diisocyanate-based foam, naphthalene diisocyanate-based foam, tolidine diisocyanate-based foam, and combinations thereof. For example, as alluded to above, when the MCU foam is virgin material or from a single source, the MCU foam is typically solely methyldiphenyl diisocyanate-based foam or naphthalene diisocyanate-based foam or tolidine diisocyanate-based foam. Alternatively, in another embodiment, the MCU foam may be a combination of methyldiphenyl diisocyanate-based foam, naphthalene diisocyanate-based foam, and tolidine diisocyanate-based foam, especially when the MCU foam is the pre-formed MCU foam. For example, when the MCU foam is recycled from a combination of slabs, trimmings, and formed articles, or is provided from multiple sources, the MCU foam is typically a combination of methyldiphenyl diisocyanate-based foam, naphthalene diisocyanate-based foam, and tolidine diisocyanate-based foam.

After pulverization, the particle size of the polyurethane powder is preferably from 0.5 to 10 mm. Alternatively, as set forth above, the polyurethane powder may be provided as a pre-made product, in which case the above steps are unnecessary. The resulting polyurethane powder typically has a melt temperature of at least 250° C., more typically at least 235° C.

After the polyurethane powder is provided, substantially all of the moisture may be eliminated from the polyurethane powder. More specifically, the moisture is typically eliminated from the polyurethane powder until the water content of the polyurethane powder is less than or equal to 0.03%. Typically, moisture is eliminated from the polyurethane powder by drying the polyurethane powder in an oven for at least 8 hours, but moisture may also be removed from the polyurethane powder with an open heat source. After the moisture is substantially eliminated from the polyurethane powder, the polyurethane powder may be stored under vacuum. Alternatively, a desiccant may be added to the polyurethane powder, or a combination of storage under vacuum and the addition of a desiccant may be employed. After substantially all of the moisture is removed from the polyurethane powder, the polyurethane powder is suitable for processing with the pre-formed TPU resin.

The method of producing the TPU compound further includes the step of providing the pre-formed TPU resin. The pre-formed TPU resin may be selected from the group of polyester-based TPU resins, polyether-based TPU resins, and combinations thereof. Typically, when both a polyester-based TPU resin and a polyether-based TPU resin are present, the polyester-based TPU resin and the polyether-based TPU resin are present in a ratio of from 1:9 to 9:1, more preferably in a ratio of from 1:7 to 7:1, and most preferably in a ratio of from 1:5 to 5:1. However, it is to be appreciated that the pre-formed TPU resin may include only polyester-based TPU resin or polyether-based TPU resin.

The polyester-based TPU resin includes the reaction product of a polyester polyol and a diisocyanate. Polyester polyols suitable for producing the polyester-based TPU resin may comprise the reaction product of a dicarboxylic acid and a glycol having at least one primary hydroxyl group. Dicarboxylic acids that are suitable for producing the polyester polyols may be selected from the group of, but are not limited to, adipic acid, methyl adipic acid, succinic acid, suberic acid, sebacic acid, oxalic acid, glutaric acid, pimelic acid, azelaic acid, phthalic acid, terephthalic acid, isophthalic acid, and combinations thereof. Glycols that are suitable for producing the polyester polyols may be selected from the group of, but are not limited to, ethylene glycol, butylene glycol, hexanediol, bis(hydroxymethylcyclohexane), 1,4-butanediol, diethylene glycol, 2,2-dimethyl propylene glycol, 1,3-propylene glycol, and combinations thereof.

Diisocyanates that are suitable for producing the polyester-based TPU resin may be selected from the group of, but are not limited to, 4,4′-diphenylmethane diisocyanate, 2,4′-diphenylmethane diisocyanate, ethylene diisocyanate, ethylidene diisocyanate, propylene diisocyanate, butylene diisocyanate, cyclopentylene-1,3-diisocyanate, cyclohexylene-1,4-diisocyanate, cyclohexylene-1,2-diisocyanate, 2,4-toluylene diisocyanate, 2,6-toluylene diisocyanate, 2,2-diphenylpropane-4,4′-diisocyanate, p-phenylene diisocyanate, m-phenylene diisocyanate, xylylene diisocyanate, 1,4-naphthylene diisocyanate, 1,5-naphthylene diisocyanate, diphenyl-4,4′-diisocyanate, azobenzene-4,4′-diisocyanate, diphenylsulfone-4,4′-diisocyanate, dichlorohexamethylene diisocyanate, tetramethylene diisocyanate, pentamethylene diisocyanate, hexamethylene diisocyanate, 1-chlorobenzene-2,4-diisocyanate, furfurylidene diisocyanate, and combinations thereof.

In addition, the polyester-based TPU resin may also include the reaction product of a suitable chain extender. Suitable chain extenders may be selected from the group of, but are not limited to, diols including ethylene glycol, propylene glycol, butylene glycol, 1,4-butanediol, butenediol, butynediol, xylylene glycols, amylene glycols, 1,4-phenylene-bis-β-hydroxy ethyl ether, 1,3-phenylene-bis-β-hydroxy ethyl ether, bis-(hydroxy-methyl-cyclohexane), hexanediol, and thiodiglycol; diamines including ethylene diamine, propylene diamine, butylene diamine, hexamethylene diamine, cyclohexalene diamine, phenylene diamine, tolylene diamine, xylylene diamine, 3,3′-dichlorobenzidine, and 3,3′-dinitrobenzidine; alkanol amines such as ethanol amine, aminopropyl alcohol, 2,2-dimethyl propanol amine, 3-aminocyclohexyl alcohol, and p-aminobenzyl alcohol; and combinations thereof. Specific examples of polyester-based TPU resin that are suitable for the purposes of the subject invention include Elastollan® 600 Series polyester-based TPU resins commercially available from BASF Corporation of Florham Park, N.J.

The polyether-based TPU resin includes the reaction product of a polyether polyol and a diisocyanate. Suitable diisocyanates include any of those mentioned above as suitable for producing the polyester-based TPU resin. Polyether polyols suitable for producing the polyether-based TPU resin may comprise the reaction product of a dicarboxylic acid and a glycol having at least one primary hydroxyl group. Glycols suitable for producing the polyether-based TPU resin may be selected from the group of, but are not limited to, polytetramethylene glycol, polyethylene glycol, polypropylene glycol, and combinations thereof. Suitable dicarboxylic acids include any of those mentioned above as suitable for producing the polyester-based TPU resin. Like the polyester-based TPU resin, the polyether-based TPU resin may also include the reaction product of a suitable chain extender, and the chain extenders set forth above are also suitable for producing the polyether-based TPU resin. Specific examples of polyether-based TPU resins that are suitable for purposes of the subject invention include Elastollan® 1100 Series polyether-based TPU resins commercially available from BASF Corporation of Florham Park, N.J.

The method of producing the TPU compound further includes the step of processing the pre-formed TPU resin and the polyurethane powder together through a first apparatus to produce a first TPU compound. In one embodiment, the first apparatus may be a twin-screw melt extruder.

The polyurethane powder and the pre-formed TPU resin are typically fed into the twin-screw melt extruder in a weight ratio of MCU to TPU of about 4:1 to form a first TPU compound with a concentration of MCU to TPU of about 4:1 based on a total weight of the first TPU compound. Preferably, the pre-formed TPU resin and the polyurethane powder are mixed together prior to feeding the pre-formed TPU resin and the polyurethane powder into the twin-screw melt extruder. However, it is to be appreciated that the pre-formed TPU resin and the polyurethane powder may be separately fed into the twin-screw melt extruder. To ensure sufficient mixing of the pre-formed TPU resin and the polyurethane powder, the twin-screw melt extruder typically mixes the pre-formed TPU resin and the polyurethane powder more effectively than a single-screw melt extruder. However, it is to be appreciated that other apparatuses may be used, such as a single-screw melt extruders with an auxiliary mixing mechanism, so long as the apparatus can accomplish suitable mixing. Additionally, the pre-formed TPU resin and the polyurethane powder are processed together at a temperature at least equal to a melt temperature of the polyurethane powder. More specifically, the pre-formed TPU resin and the polyurethane powder are processed together through the twin-screw melt extruder at a temperature of at least 225° C., which, as set forth above, is the just below the melt temperature of the polyurethane powder. Consequently, 225° C. is the melt temperature of the first TPU compound.

After the pre-formed TPU resin and the polyurethane powder are compounded, the resulting first TPU compound may be removed from the twin-screw melt extruder. For example, in one embodiment, the first TPU compound may be extruded and pelletized in a strand pelletizer to form the first TPU compound. In one embodiment, the first TPU compound may be packaged for future processing or may be processed after pelletizing without packaging. The first TPU compound is processed further to produce a second TPU compound. The second TPU compound is the TPU compound of the subject invention.

For the step of processing the first TPU compound to produce the second TPU compound, a supplemental amount of the pre-formed TPU resin and the first TPU compound are processed together through a second apparatus to produce the second TPU compound. It is to be appreciated that the second apparatus may or may not be the same physical apparatus as the first apparatus. That is, the pre-formed TPU resin and the polyurethane powder that form the first TPU compound, and the supplemental amount of the pre-formed TPU resin and the first TPU compound that form the second TPU compound, may be processed together through one apparatus, or through two separate apparatuses. Further, the first apparatus and the second apparatus may be the same or different types. For example, the first apparatus may be a twin-screw melt extruder and the second apparatus may be a single-screw melt extruder.

The supplemental amount of the pre-formed TPU resin and the first TPU compound are typically fed into the second apparatus in amounts sufficient to form a second TPU compound with a concentration of MCU to TPU of about 1:1 based on a total weight of the second TPU compound. In one embodiment, the second apparatus may be a twin-screw melt extruder. Preferably, the supplemental amount of the pre-formed TPU resin and the first TPU compound are mixed together prior to feeding the supplemental amount of the pre-formed TPU resin and the first TPU compound into the twin-screw melt extruder. However, it is to be appreciated that the supplemental amount of the pre-formed TPU resin and the first TPU compound may be separately fed into the twin-screw melt extruder. To ensure sufficient mixing of the supplemental amount of the pre-formed TPU resin and the first TPU compound, the twin-screw melt extruder typically mixes the supplemental amount of the pre-formed TPU resin and the first TPU compound more effectively than a single-screw melt extruder. However, it is to be appreciated that other apparatuses may be used, such as a single-screw melt extruder with an auxiliary mixing mechanism, so long as the apparatus can accomplish suitable mixing. Additionally, the supplemental amount of the pre-formed TPU resin and the first TPU compound are typically processed together at a temperature at least equal to a minimum melt temperature of the first TPU compound. More specifically, the supplemental amount of the pre-formed TPU resin and the first TPU compound are typically processed together through the twin-screw melt extruder at a temperature of at least 225° C., which, as set forth above, is the melt temperature of the first TPU compound. Consequently, the second TPU typically has a melt temperature of 225° C.

After the supplemental amount of the pre-formed TPU resin and the first TPU compound are compounded, the second TPU compound may be removed from the twin-screw melt extruder. For example, in one embodiment, the second TPU compound may be extruded, pelletized in a strand pelletizer to form the second TPU compound, and packaged for future use. In another embodiment, the second TPU compound may be extruded and pelletized in a strand pelletizer to form the second TPU compound, which is subsequently processed further to produce a TPU article.

More specifically, the second TPU compound may be processed through a third apparatus to produce a TPU article. In one embodiment, the second TPU compound may be processed in a single-screw melt extruder, twin-screw melt extruder, or a strand pelletizer for further processing into strands of polyurethane. In another embodiment, the second TPU compound may be injected into an injection molding device to produce the TPU article. The second TPU compound may typically be processed in the injection molding device at a temperature at least equal to the melt temperature of the polyurethane powder. The temperature in a barrel of the injection molding device typically increases by approximately 10-20° C. from a freezing zone to a metering zone of the barrel. A nozzle temperature of the injection molding device is typically about 250° C. A screw diameter of the injection molding device is typically about 75 mm. A corresponding screw speed of the injection molding device is typically about 250 rpm. A typical back pressure of the injection molding device is between 50 and 150 psi, preferably 100 psi. A typical injection speed for the injection molding device is between 0.5 and 3.0 inch/sec, preferably 1.0 inch/sec.

As mentioned above, the resulting TPU compound melts at a higher temperature than other commercially available TPU compounds, and exhibits high elongation, elasticity, tensile strength, tear, and abrasion resistance, and hardness. More specifically, the TPU compound typically has a melt temperature of at least 225° C., which makes the TPU compound suitable for many applications for which a traditional TPU compound is not suitable. Additionally, the TPU compound typically has a compression set at 100° C. that is at least 40% lower than the compression set of a TPU compound that is free of the polyurethane powder, which makes the TPU compound suitable for many applications requiring consistent deformation properties in a high temperature environment. Further, the TPU compound typically has an elongation at break of about 373 and an elastic modulus of about 1,556 psi as measured by the ASTM D412 test method. The TPU compound typically has a 300% modulus of about 1,831 psi, a 100% modulus of about 884 psi, and a 50% modulus of about 574 psi as determined by the ASTM D412 test method. The TPU compound typically has a tensile strength of about 2,040 psi as measured by the ASTM D638 test method. The TPU compound typically has a Die C tear at 20 N/mm of about 375 as measured by the ASTM D624 test method, a Taber Abrasion of about 375 as measured by the ASTM D1044 test method, and a Shore A hardness of about 80 as determined by the ASTM D2240 test method.

The TPU compound typically has the above properties without the need for plasticizers. However, it is to be appreciated that plasticizers and other optional components known in the art for including in TPU compounds may also be included in the TPU compound of the present invention.

Similarly, the resulting TPU article formed from the TPU compound melts at a higher temperature than other commercially available TPU articles, and exhibits high elongation, elasticity, tensile strength, tear and abrasion resistance, and hardness. More specifically, the TPU article typically has a melt temperature of at least 225° C., which makes the TPU article suitable for many applications for which a traditional TPU article is not suitable. Additionally, the TPU article typically has a compression set at 100° C. that is at least 40% lower than the compression set of a TPU article that is free of the polyurethane powder, which makes the TPU article suitable for many applications requiring consistent deformation properties in a high temperature environment. Further, the TPU article typically has an elongation at break of about 373 and an elastic modulus of about 1,556 psi as measured by the ASTM D412 test method. The TPU article typically has a 300% modulus of about 1,831 psi, a 100% modulus of about 884 psi, and a 50% modulus of about 574 psi as determined by the ASTM D412 test method. The TPU article typically has a tensile strength of about 2,040 psi as measured by the ASTM D638 test method. The TPU article typically has a Die C tear at 20 N/mm of about 375 as measured by the ASTM D624 test method, a Taber Abrasion of about 375 as measured by the ASTM D1044 test method, and a Shore A hardness of about 80 as determined by the ASTM D2240 test method.

### EXAMPLES

The following Examples are meant to illustrate the invention and are not to be viewed in any way as limiting to the scope of the invention.

A thermoplastic polyurethane (TPU) compound is produced in accordance with the method of the present invention. More specifically, the TPU compound is produced by blending a polyurethane powder with a pre-formed TPU resin in a twin-screw melt extruder. In Example A, 700 pounds of the polyurethane powder and 300 pounds of the pie-formed TPU resin are charged to the twin-screw melt extruder after the polyurethane powder and the pre-formed TPU resin have been dried for about 8 hours at about 82° C. The polyurethane powder and the pre-formed TPU resin are fed to the twin-screw melt extruder separately via a loss weight scale into an entrance of the twin-screw melt extruder. The twin-screw melt extruder includes two screws and multiple stages with kneeding blocks. The outside diameter of each screw is 70 mm. The speed of the twin-screw melt extruder is about 250-300 rpm. A strand pelletizer at an exit of the twin-screw melt extruder includes a die face that is single-tier with 20 holes each having a ⅛ inch outside diameter. In operation, the strand pelletizer produces 20 strands of a first TPU compound. The 20 strands of the first TPU compound pass through the 20 holes into a 15-foot water trough to cool the 20 strands. After cooling, the 20 strands of the first TPU compound are pulled into a pelletizing cutter having about a ⅛ inch diameter and a length of from about ¼ to ⅛ inch to pelletize the first TPU compound. The temperatures along the stages of the twin-screw melt extruder range from about 193° C. to 221° C. The twin-screw melt extruder with the strand pelletizer produces from about 500 to 750 pounds of the first TPU compound per hour.

To form a second TPU compound, which is the TPU compound of the subject invention, 700 pounds of the first TPU compound and 700 pounds of the pre-formed TPU resin are charged to the twin-screw melt extruder after the first TPU compound and the pre-formed TPU resin have been dried for about 8 hours at about 82° C. The first TPU compound and the pre-formed TPU resin are fed to the twin-screw melt extruder separately via the loss weight scale into the entrance of the twin-screw melt extruder. The twin-screw melt extruder includes two screws and multiple stages with kneeding blocks. The outside diameter of each screw is 70 mm. The speed of the twin-screw melt extruder is about 250-300 rpm. The strand pelletizer at the exit of the twin-screw melt extruder includes the die face that is single-tier with 20 holes each having a ⅛ inch outside diameter. In operation, the strand pelletizer produces 20 strands of the second TPU compound. The 20 strands of the second TPU compound pass through the 20 holes into the 15-foot water trough to cool the 20 strands. After cooling, the 20 strands of the second TPU compound are pulled into the pelletizing cutter having about a ⅛ inch diameter and a length of from about ¼ to ⅛ inch to pelletize the second TPU compound. The temperatures along the stages of the twin-screw melt extruder range from about 193° C. to 221° C. The twin-screw melt extruder with the strand pelletizer produces from about 500 to 750 pounds of the second TPU compound per hour. The second TPU compound is the TPU compound of the present invention.

A conventional TPU compound is produced for comparison to the TPU compound of the present invention. The conventional TPU compound is produced by processing the pre-formed TPU resin in the twin-screw melt extruder. In Comparative Example B, 1,000 pounds of the pre-formed TPU resin are charged to the twin-screw melt extruder after the pre-formed TPUT resin has been dried for about 8 hours at about 82° C. The pre-formed TPU resin is fed to the twin-screw melt extruder via the loss weight scale into the entrance of the twin-screw melt extruder. The twin-screw melt extruder includes two screws and multiple stages with kneeding blocks. The outside diameter of each screw is 70 mm. The speed of the twin-screw melt extruder is about 250-300 rpm. The strand pelletizer at the exit of the twin-screw melt extruder includes the die face that is single-tier with 20 holes each having a ⅛ inch outside diameter. In operation, the strand pelletizer produces 20 strands of the conventional TPU compound. The 20 strands of the conventional TPU compound pass through the 20 holes into the 15 foot water trough to cool the 20 strands. After cooling, the 20 strands of the conventional TPU compound are pulled into the pelletizing cutter having about a ⅛ inch diameter and a length of from about ¼ to ⅛ inch to pelletize the conventional TPU compound. The temperatures along the stages of the twin-screw melt extruder range from about 193° C. to 221° C. The twin-screw melt extruder with the strand pelletizer produces from about 500 to 750 pounds of the conventional TPU compound per hour.

The specific amounts of each component in the TPU compound and the conventional TPU compound are indicated below in Table 1, wherein all amounts are in parts by weight based on the total weight of the TPU compound.

TABLE 1

| | | |
|---|---|---|
| Component | Ex. A | Comp. Ex. B |

| | | | |
|---|---|---|---|
| TPU Resin | TPU A | 20.00 | 0.00 |
| | TPU B | 0.00 | 100.00 |
| Polyurethane Powder | MCU A | 40.00 | 0.00 |
| | MCU B | 40.00 | 0.00 |
| Total | | 100.00 | 100.00 |

TPU A is a polyester-based TPU commercially available under the trade name Elastollan ® 1164D from BASF Corporation;
TPU B is a polyether-based TPU commercially available under the trade name Elastollan ® 1175A10W from BASF Corporation;
MCU A is a methyldiphenyl diisocyanate-based microcellular polyurethane foam having a melt temperature of 200° C. commercially available under the trade name Cellasto ® from BASF Corporation; and
MCU B is a naphthalene diisocyanate-based microcellular polyurethane foam having a melt temperature of 250° C. commercially available under the trade name Cellasto ® from BASF Corporation.

The second TPU compound, which is the TPU compound of the present invention, is injected into an injection molding device to produce a TPU article. The second TPU compound is processed in the injection molding device at a temperature of 225° C. The temperature in a barrel of the injection molding device increases by approximately 10-20° C. from a freezing zone to a metering zone of the barrel. A nozzle temperature of the injection molding device is about 250° C. A screw diameter of the injection molding device is about 75 mm. A corresponding screw speed of the injection molding device is about 250 rpm. A back pressure of the injection molding device is about 100 psi. An injection speed for the injection molding device is 1.0 inch/sec.

For comparison, the conventional TPU compound is injected into the injection molding device to produce a conventional TPU article. The conventional TPU compound is processed in the injection molding device at a temperature of 225° C. The temperature in the barrel of the injection molding device increases by approximately 10-20° C. from the freezing zone to the metering zone of the barrel. The nozzle temperature of the injection molding device is about 250° C. The screw diameter of the injection molding device is about 75 mm. The corresponding screw speed of the injection molding device is about 250 rpm. The back pressure of the injection molding device is about 100 psi. The injection speed for the injection molding device is 1.0 inch/sec.

The physical properties of the TPU article including the TPU compound and the conventional TPU article including the conventional TPU compound described above are indicated below in Table 2.

TABLE 2

| Physical Property | Ex. A | Comp. Ex. B |
|---|---|---|
| Melt temperature (° C.) | 225 | 150 |
| 22 hr. Compression set at 100° C. (%) | 61 | 87 |
| Elongation at break (%) | 387 | 559 |
| Elastic modulus (psi) | 1237 | 1815 |
| 50% modulus (psi) | 465 | 487 |
| Tensile strength (psi) | 1283 | 2893 |
| Die C tear (N/mm) | 258 | 398 |
| Taber abrasion (mg loss) | 23 | 57 |
| Shore hardness | 75A | 75A |

### Analysis of Results

As is apparent through comparison of the physical properties of the TPU compounds of the present invention, as illustrated by Example A, to the physical properties of the conventional TPU compounds illustrated by Comparative Example B, TPU articles including the TPU compounds of the present invention exhibit superior melt temperature as compared to the conventional TPU articles including the conventional TPU compounds of equal Shore hardness. Similarly, the TPU articles including the TPU compounds of the subject invention exhibit superior compression set as compared to the conventional TPU articles including the conventional TPU compounds of equal Shore hardness. Consequently, the TPU compounds of the present invention are more suitable than the conventional TPU compounds for many applications that require a consistent deformation performance in a high temperature environment.

Obviously, many modifications and variations of the present invention are possible in light of the above teachings. The invention may be practiced otherwise than as specifically described within the scope of the appended claims.

What is claimed is:

1. A method of producing a thermoplastic polyurethane (TPU) compound, said method comprising the steps of:
providing a polyurethane powder comprising microcellular polyurethane (MCU);
providing a pre-formed TPU resin;
processing the pre-formed TPU resin and the polyurethane powder together through a first apparatus to produce a first TPU compound; and
processing a supplemental amount of the pre-formed TPU resin and the first TPU compound together through a second apparatus to produce a second TPU compound.

2. A method as set forth in claim 1 wherein the first TPU compound and the second TPU compound have a melt temperature of at least 225° C.

3. A method as set forth in claim 1 wherein the first TPU compound has a concentration of MCU to TPU of about 4:1 based on a total weight of the first TPU compound.

4. A method as set forth in claim 3 wherein the second TPU compound has a concentration of MCU to TPU of about 1:1 based on a total weight of the second TPU compound.

5. A method as set forth in claim 1 wherein the pre-formed TPU resin and the polyurethane powder are processed together through the first apparatus at a temperature of from 225° C. to 250° C.

6. A method as set forth in claim 5 wherein the supplemental amount of pre-formed TPU resin and the first TPU compound are processed together through the second apparatus at a temperature at least equal to a melt temperature of the first TPU compound.

7. A method as set forth in claim 1 wherein the polyurethane powder is selected from the group of methyldiphenyl diisocyanate-based foam powders, naphthalene diisocyanate-based foam powders, tolidine diisocyanate-based foam powders, and combinations thereof.

8. A method as set forth in claim 1 wherein the polyurethane powder has a particle size of from 0.5 to 10 mm.

9. A method as set forth in claim 1 further comprising the step of substantially eliminating moisture from the polyurethane powder.

10. A method as set forth in claim 9 wherein said step of substantially eliminating moisture from the polyurethane powder comprises storing the polyurethane powder under vacuum.

11. A method as set forth in claim 9 wherein said step of substantially eliminating moisture from the polyurethane powder comprises adding a desiccant to the polyurethane powder.

12. A method as set forth in claim 1 further comprising the step of processing the second TPU compound through a third apparatus to produce a TPU article.

13. A method as set forth in claim 12 wherein the TPU article has a compression set at 100° C. that is at least 40% lower than the compression set at 100° C. of a TPU article that is free of the polyurethane powder, as measured by ASTM test standard D395.

14. A method of recycling a pre-formed microcellular polyurethane (MCU) foam, said method comprising the steps of:
providing the pre-formed MCU foam;
pulverizing the pre-formed MCU foam to produce a polyurethane powder comprising MCU;
providing a pre-formed thermoplastic polyurethane (TPU) resin;
processing the polyurethane powder and the pre-formed TPU resin together through a first apparatus to produce a first TPU compound; and
processing a supplemental amount of the pre-formed TPU resin and the first TPU compound together through a second apparatus to produce a second TPU compound.

15. A method as set forth in claim 14 wherein the first TPU compound and the second TPU compound have a melt temperature of at least 225° C.

16. A method as set forth in claim 14 wherein the first TPU compound has a concentration of MCU to TPU of about 4:1 based on a total weight of the first TPU compound.

17. A method as set forth in claim 16 wherein the second TPU compound has a concentration of MCU to TPU of about 1:1 based on a total weight of the second TPU compound.

18. A method as set forth in claim 14 further comprising the step of processing the second TPU compound through a third apparatus to produce a TPU article.

19. A method as set forth in claim 18 wherein the TPU article has a compression set at 100° C. that is at least 40% lower than the compression set at 100° C. of a TPU article that is free of the polyurethane powder, as measured by ASTM test standard D395.

20. A method as set forth in claim 18 wherein the third apparatus is selected from the group of melt extruders and injection molding devices.

21. A method as set forth in claim 14 wherein the polyurethane powder and the preformed TPU resin are processed together through the first apparatus at a temperature of at least 225° C.

22. A method as set forth in claim 14 wherein the first apparatus and the second apparatus are each a compounding device.

23. A method as set forth in claim 22 wherein each compounding device is a melt extruder.

24. A method as set forth in claim 21 wherein the supplemental amount of pre-formed TPU resin and the first TPU compound are processed together through the second apparatus at a temperature of at least 225° C.

25. A method as set forth in claim 14 wherein the polyurethane powder is selected from the group of methyldiphenyl diisocyanate-based foam powders, naphthalene diisocyanate-based foam powders, tolidine diisocyanate-based foam powders, and combinations thereof.

26. A method of producing a thermoplastic polyurethane (TPU) compound, said method comprising the steps of:
providing a polyurethane powder comprising microcellular polyurethane (MCU);
providing a pre-formed TPU resin;
processing the pre-formed TPU resin and the polyurethane powder together through a first apparatus to produce a first TPU compound having a melt temperature of at least 225° C.; and
processing a supplemental amount of the pre-formed TPU resin and the first TPU compound together through a second apparatus to produce a second TPU compound having a melt temperature of at least 225° C.

27. A method as set forth in claim 26 further comprising the step of processing the second TPU compound through a third apparatus to produce a TPU article, wherein the TPU article has a compression set at 100° C. that is at least 40% lower than the compression set at 100° C. of a TPU article that is free of the polyurethane powder, as measured by ASTM test standard D395.

28. A method as set forth in claim 26 wherein the first TPU compound has a concentration of MCU to TPU of about 4:1 based on a total weight of the first TPU compound.

29. A method as set forth in claim 28 wherein the second TPU compound has a concentration of MCU to TPU of about 1:1 based on a total weight of the second TPU compound.
